(19) United States
(12) Patent Application Publication
(10) Pub. No.: US 2022/0023968 A1
(43) Pub. Date: Jan. 27, 2022

(54) A TOOL ASSEMBLY FOR FRICTION STIR WELDING

(71) Applicant: ELEMENT SIX (UK) LIMITED, Oxfordshire (GB)

(72) Inventors: Geoffrey Alan SCARSBROOK, Oxfordshire (GB); David Christian BOWES, Oxfordshire (GB); Shuo LU, Oxfordshire (GB); Santonu GHOSH, Oxfordshire (GB); Teresa RODRIGUEZ SUAREZ, Oxfordshire (GB)

(21) Appl. No.: 17/299,503

(22) PCT Filed: Dec. 5, 2019
(86) PCT No.: PCT/EP2019/083786

§ 371 Date: Jun. 3, 2021

(30) Foreign Application Priority Data
Dec. 5, 2018 (GB) 1819835.8

(51) Int. Cl. B23K 20/12

(52) U.S. Cl. CPC B23K 20/1255; B23K 20/123

(57) ABSTRACT

This disclosure relates to a tool assembly for friction stir welding. The tool assembly comprises a tool holder and a puck each having an axis of rotation. The tool holder comprises a tool post and the puck comprises a pin. The puck is coupled to the tool post. The tool assembly is adapted such that during friction stir welding, run-out of the tool holder, measured as the run-out between the axis of rotation of the tool holder and the axis of rotation of the pin, does not exceed 10 μm.

### FIELD OF THE INVENTION

This invention relates to the field of friction stir welding (FSVV) and in particular to a FSW tool assembly which holds a super-abrasive puck firmly during FSW of high melting point materials such as iron based alloys, and in which the puck is preferably replaceable.

### BACKGROUND ART

In fabrication of metal assemblies, particularly structural metal assemblies most commonly made of steel, there is often the requirement to join two materials together. A number of options exist for this, including welding, brazing, riveting, etc., but each of these processes has its advantages and disadvantages. Two key issues are:
i) Is the joining continuous (like a continuous weld) or discrete (e.g. riveting)? Discrete joining points do not make full use of the strength of the material along the join line, and so ultimately, the structure will be heavier than with the ‘perfect’ continuous weld.
ii) If a continuous join, do the properties of the join match or exceed the properties of the surrounding material, or do they form a weak point?

For large engineering structures, the most common form of joining is using welding, most commonly a type of gas-shielded arc welding using a filler rod, although many variants of welding exist. In common to all of them however are the following features:
a) The joint is molten for a short period, requiring a substantial amount of heat to be put into the surrounding metal as well as into the joint itself; and
b) As a result of the total amount of heat, the cool down from being molten at the joint is slow, which can result in substantial grain growth and phase segregation in this region.

Unfortunately in some steels, for example in high strength high carbon steels, conventional welding is not always feasible, and the grain growth and phase segregation that occurs in conventional welds may make them weak and prone to failure so that the weld is very often the weakest part of the structure.

In the early 1990's, The Welding Institute (TWI) developed an alternative to the various forms of arc welding called ‘friction stir welding’ (FSW), and this technique is now well established in low melting point metals and alloy such as Al and its alloys, where a suitable machine tool for the process can be manufactured from a conventional tool steel. The advantage of FSW is that welding occurs significantly below the melting point and the heating is much more localised, so that the cooling rate after welding is higher, reducing growth and phase segregation. The result is that the weld may be as strong and environmentally stable as the parent material.

There has always been the desire to translate these benefits to joining steels, but FSW in steels puts massive demands on the tool used. In particular, typical weld temperatures can be around 1100° C., the forces applied to the tool embedded in a solid but plastically flowing steel work piece are very high, and the environment is both highly abrasive and chemically aggressive.

There is currently a limited supply of FSW tools into the market for use with steels, but in general these have had a low level of adoption. Tool materials for FSW vary with application details, but typically, they comprise polycrystalline cubic boron nitride (PCBN) grit sintered in a tungsten-rhenium (VV-Re) binder material, the W-Re binder material providing toughness and the PCBN grit providing the abrasion resistance.

The low level of adoption appears to be because of the unreliability of the tool performance, with market reports suggesting a minimum acceptable tool lifetime of 30 metres of weld, but reporting that this is not routinely achieved. Despite the use of these highly engineered materials, W-Re and PCBN, the two failure modes are wear, losing key shape features on the tool which affect weld performance, and fracture, often causing the central ‘stirring pin’ of the tool to break off completely.

The precise composition and microstructure of the PCBN/W-Re sintered ‘puck’ (described in more detail below) used to fabricate the tool is obviously one relevant factor in failure due to fracture. There is a balance to be struck between adding more W-Re, which adds to the cost and to the toughness, and adding more PCBN, which adds to the wear resistance but increases the risk of fracture. One can argue that the wear properties of the puck are currently constrained by the high reliance on the W-Re, a constraint which may be reduced if another solution is found to the tool fracture issue.

PCBN, as a grit or in sintered form with a range of binders including W-Re, is one of a range of materials termed ‘super-abrasives’. Whilst PCBN/W-Re is currently the best performing of the conventional super-abrasives, the invention described in later sections of this description is not restricted to PCBN, for example anticipating the advent of high entropy alloys with suitable toughness and abrasive properties for use as the binder, or stand-alone in some applications. Throughout the remainder of this description, the term puck is used for the component that is shaped into the end element of the FSW tool assembly, and is in direct contact with the material being welded. Typically, this is shaped on the face in contact with the metal being welded to form a shoulder and a stirring pin, often with a reverse spiral cut into the surface so that during rotation it pulls metal towards the pin and pushes this down into the hole being formed by the pin. A ‘super-abrasive puck’ is a puck that comprises a super-abrasive grit or comprises a high entropy alloy.

Typically, the super-abrasive puck is held by a metal collar onto a post which is inserted into a conventional collet or keyed tool mount of a milling or dedicated FSW machine. Typically, the post, referred hereinafter as the ‘tool post’, is made from tungsten carbide, however other materials can be used and are envisaged in the invention described later in this description.

The other key factor in terms of tool lifetime, particularly with respect to cracking, is the design of the tool holder. Conventional tool holders comprise an initially round tungsten carbide (W-C) shaft, processed to have multiple facets, typically eight, then processed onto it, abutted up to a shaped super-abrasive puck that also has multiple facets processed onto it. Across the abutted join is shrink fitted a metal collar, with a matching eight-faceted internal bore. The concept is that the collar, having been shrink fitted onto the two components, mechanically locks them both together, with the multiple facets providing additional torque transfer when the tool is in use.

Although conditions of use vary substantially, for a 6 mm long pin, suitable for welding 6 mm thick abutted plates, the forces can be:

| | | |
|---|---|---|
| Axial force | 80 kN | (pressing tool into metal being welded) |
| Lateral force | 20 kN | (traversing the tool along the line of the weld) |
| Torque | 400 Nm | (torque applied to maintain the rotation of the tool) |

Evidence now suggests that the problem is with the use of a shrink fitted collar. The coefficient of thermal expansion (CTE) of the super-abrasive puck is generally low, for example with a W-Re/PCBN puck it is around 4.5 ppm/° C., similar to that of W-C, whereas the CTE of a typical metal used for a heat shrink ring is around 11 ppm/° C. Heat shrinking as a general process usually involves heating the component to be shrink fitted up to around 600° C. before fitting it in place to shrink down. However, with an operating temperature of around 1100° C. during the weld, the shrink fitted collar tends to expand again, much more than the super-abrasive puck, making the collar a sloppy fit for the super-abrasive puck. The faceted shape internal to the collar and external to the puck ensures that the puck rotates, but now the puck can also move slightly laterally in the collar, resulting in what is generally termed ‘run-out’—rotation of the puck with the pin being slightly off the axis of rotation. Any such run-out on the tool results in much higher cyclic forces on the pin as it wobbles in the plastically flowing steel, leading to much more severe fatigue and crack propagation, and ultimately failure.

Run-out is a common issue in machining applications, and comprises the run-out of the machine and the tool holder/tool in use. FSW can be completed by standard milling machines in many cases, or by what are essentially modified milling machine designs sold especially for FSW. Throughout this specification, the machine will be referred to as a FSW machine, and this will refer to any machine suitable for FSW.

In general, FSW operations comprise a number of steps, for example:
a) an insertion step, from the point when the tool comes into contact with the workpiece to the point where the pin is fully embedded up to the shoulder in the heated and softened workpiece,
b) a tool traverse, when the tool moves laterally along the line in between the workpiece(s) to be joined, and
c) an extraction step, when the tool is lifted or traversed out of the workpiece.

The tool traverse, which is the stage primarily forming the weld, is usually performed under constant conditions; typically these conditions are rotational speed, depth of plunge, speed of traverse etc, although in some instances speeds may be replaced by applied power, and depths by applied forces, giving similar results but allowing responsiveness to local workpiece variations. In any event, once the tool traverse is initiated, the conditions remain essentially constant for the duration of the traverse until the end of the weld is approached. These are the conditions referred to throughout this document as being ‘steady state operation’.

One superficially obvious solution to avoiding thermal expansion problems within the tool holder is to make the super-abrasive puck so large that it fits directly into a standard FSW machine. This solution is impractical for two reasons:
a) Presses capable of the very high pressures used for sintering and suitable for manufacturing such large super-abrasive pucks are not available, and
b) The cost of the super-abrasive puck (filler +binder) would be prohibitively expensive.

Consequently, the problem in its simplest form is essentially one of how to suitably join a super-abrasive puck to a tool post, which can then by some means be connected to a standard FSW machine, whilst ensuring that the contribution to the run-out of the tool holder in use is minimised during FSW operations in high melting point metals such as steels.

It is an object of the invention to address the above-mentioned problems.

### SUMMARY OF THE INVENTION

In one aspect of the invention, there is provided a tool assembly for friction stir welding high melting point metals and alloys, the tool assembly comprising a tool holder and a super-abrasive puck, the tool holder and the puck each having an axis of rotation, the tool holder comprising a tool post and the puck comprising a pin, the puck being coupled to the tool post, wherein the tool assembly is adapted such that during friction stir welding, run-out of the tool holder, measured as the run-out between the axis of rotation of the tool holder and the axis of rotation of the pin, does not exceed 10 μm.

Run-out is minimised by addressing two key aspects of the tool assembly design: 1) materials selection, such that where feasible CTE mismatch between structural components is minimised, and 2) structural design, such as the use of tapered fittings.

The tool assembly may be adapted in either or both of the following ways:

1) The puck is connected to the tool holder by one or more tapered joint arrangements, such that the axial forces of the FSW process push the tapered components together, taking up any slack in the joint arising from CTE mismatch.

2) Any structural element forming part of the tool assembly, which is defined by being a region of the tool which reaches a temperature of 400° C. or higher during use and where the CTE exceeds 10 ppm/° C., has a smallest linear dimension (during use) which does not exceed 3 mm. The smallest linear dimension preferably does not exceed 2.0 mm, 1.5 mm, 1.0 mm or 0.5 mm.

A high melting point metal or alloy is defined as one in which one or more of the following apply: the melting point exceeds 1200° C., or where the temperature of the workpiece adjacent to the pin during the operation of FSW exceeds 900° C.

For clarity, the above-mentioned conditions that occur during FSW are considered to occur when the puck temperature or the temperature of the workpiece adjacent to the pin has reached within 10% of steady state operating temperature. Optionally, this may be within 5%, 3%, 1% of steady state operating temperature.

The aforementioned ‘structural element forming part of the tool assembly’ is defined by being a region achieving both a minimum temperature in operation and having a minimum CTE, and is a contiguous region of the tool holder and/or the puck; furthermore, it may comprise more than one material or sub element. The CTE defining said structural element may alternatively be 9 ppm/° C., 8 ppm/° C., 7 ppm/° C., or 6 ppm/° C., and the temperature reached in order to define this region may be 300° C., 200° C., or 100° C. The smallest linear dimension of this region (the ‘thickness’) may be the wall thickness of a cylinder or hollow cone, but it may also be the thickness of a layer orthogonal to and coaxial with the longitudinal axis of the tool holder.

Other optional features of this aspect of the invention are provided in dependent claims 2 to 27.

Any tapered joint arrangements present may have screws or other locking devices designed to ensure that the tool assembly stays together during hot extraction from the workpiece, but which do not interfere with the tapered joint(s) compression to retain a tight fit as the assembly heats up.

In a further aspect of the invention, there is provided a method of removing the puck from the tool assembly, comprising the steps of:
a) Drilling into the puck to create a blind drill hole;
b) Inserting an extractor pin into the drill hole;
c) Engaging the extractor pin with the puck;
d) Removing the puck from the joining collar.

The step of engaging the extractor pin with the puck may comprise using a screw thread or expanding barbs to achieve engagement.

The method may further comprise the step of heating the joining collar prior to step a).

### BRIEF DESCRIPTION OF THE DRAWINGS

The invention will now be more particularly described, by way of example only, with reference to the accompanying drawings, in which:

FIG. 1 shows a schematic side view of an assembled prior art tool assembly comprising a tool post, a puck and joining collar;

FIG. 2 shows a schematic side view of the tool post of FIG. 1;

FIG. 3 shows a schematic end view of the tool post of FIG. 2;

FIG. 4 shows a schematic side view of the joining collar of FIG. 1;

FIG. 5 shows a schematic end view of the joining collar of FIG. 4;

FIG. 6 shows a schematic side view of the puck of FIG. 1;

FIG. 7 shows a schematic end view of the puck of FIG. 6;

FIG. 8 shows a schematic side view of an assembled tool assembly in an embodiment of the invention;

FIG. 9 shows a schematic front view of the tool post of FIG. 8;

FIG. 10 shows a schematic end view of the tool post of FIG. 9;

FIG. 11 shows a schematic side view of the joining collar of FIG. 8;

FIG. 12 shows a schematic end view of the joining collar of FIG. 11;

FIG. 13 shows a schematic side view of the puck of FIG. 8;

FIG. 14 shows a schematic end view of the puck of FIG. 13;

FIG. 15 shows how angle θ₁ is measured relative to the puck of FIG. 8;

FIG. 16 shows how angles θ₂ and θ₃ are measured relative to the joining collar of FIG. 8;

FIG. 17 shows how angle θ₄ is measured relative to the tool post of FIG. 8;

FIG. 18 shows schematic end views of two alternative embodiments of the joining collar;

FIG. 19 indicates an enlarged portion of the puck of FIG. 8 and various significant external angles α₁ and α₂ thereof;

FIG. 20 indicates an enlarged portion of the joining collar of FIG. 8 and various significant internal angles β₁ and β₂ thereof;

FIG. 21 is a graph indicating the average CTE of various alloys;

FIG. 22 is a graph indicating the tensile strength of various alloys; and

FIG. 23 is a graph indicating the creep rupture properties of various alloys. In the drawings, similar parts have been assigned similar reference numerals.

### DETAILED DESCRIPTION

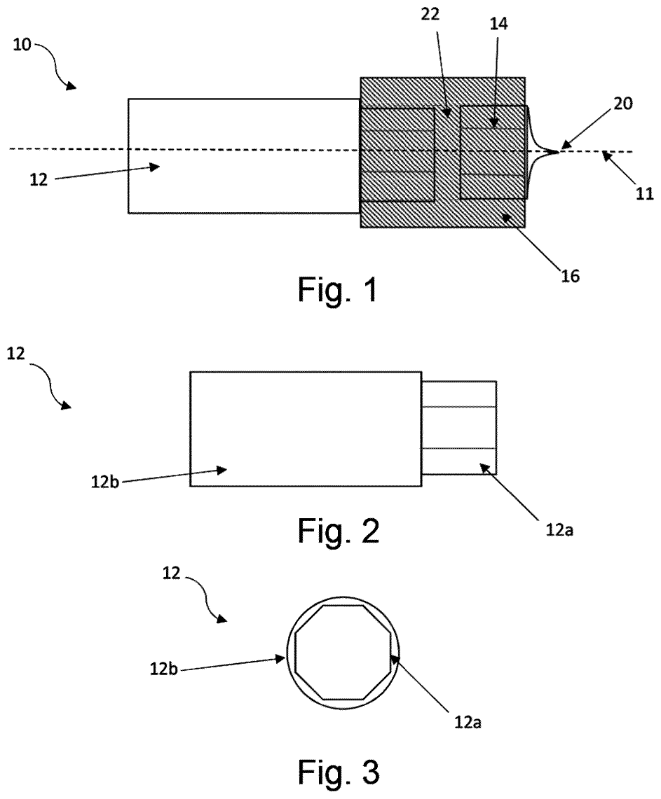

Referring firstly to FIGS. 1 to 7, a prior art tool assembly is indicated generally at 10. The tool assembly has a central longitudinal axis 11. The tool assembly comprises an elongate tool post 12, a puck 14 and a joining collar 16 mounted about the tool post 12 and the puck 14 to secure the tool post 12 and the puck 14 in axial alignment.

Under perfect FSW conditions, the tool assembly 10 is rotational about the same central longitudinal axis 11. However, when run-out occurs, the rotational axis of the puck 14 becomes displaced, and out of alignment with the rotational axis of the tool post 12. Such misalignment is commonly understood to be measured linearly, for example, the amplitude of an oscillation about the central longitudinal axis 11.

The tool post 12 comprises conjoined first and second body portions 12a, 12b, the first body portion 12a being nearest the puck 14. The first body portion 12a is octagonal in axial (i.e. lateral) cross-section. The second body portion 12b is circular in axial cross-section. The tool post 12 s radially stepped part-way along its length.

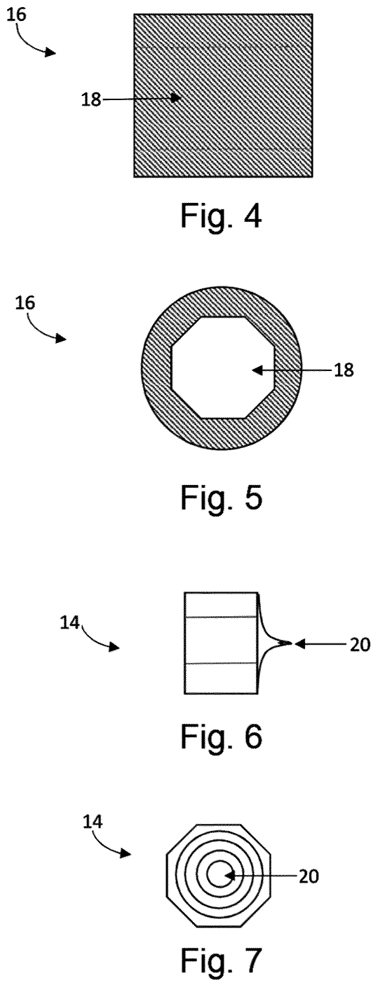

The metal joining collar 16 is externally cylindrical and has a central bore 18 extending axially along its length, as best seen in FIGS. 4 and 5. The bore 18 is octagonal in lateral cross-section, to enable coupling with the first body portion 12a of the tool post 12.

The puck 14 is octagonal in lateral cross-section. The size of the puck 14 matches that of the first body portion 12a of the tool post 12, as shown in FIG. 1. At one opposing end of the puck 14, distant from the tool post 12, the puck 14 is shaped into a stirring pin 20. The puck tapers radially inwardly (indicated in FIG. 7 by concentric circles) to a tip, which comes into contact with the components being welded in use.

The puck 14 and the tool post 12 are separated axially by a gap 22 and secured in position relative to each other by virtue of the joining collar 16 shrink fitted onto the puck 14 and tool post 12. Conventionally, the puck 14 and tool post 12 abut one another though and are mechanically locked in place, as mentioned earlier.

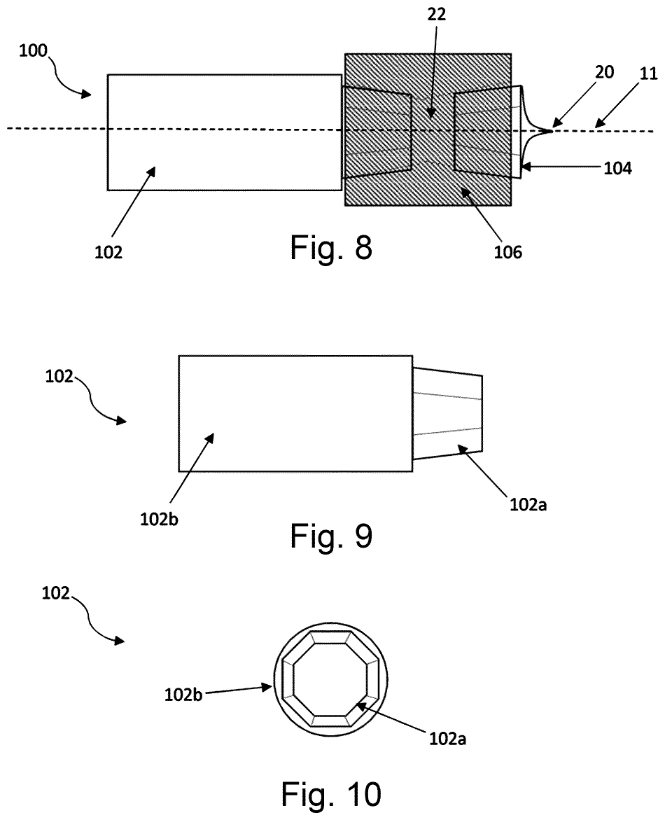

Turning now to FIGS. 8 to 14, a first embodiment of the tool assembly according to the invention is indicated generally at 100. The tool assembly comprises a tool post 102, a super-abrasive puck 104 and a joining collar 106. The joining collar 106 is shrink fitted onto the tool post 102 and the super-abrasive puck 104.

The tool post 102 comprises conjoined first and second body portions 102a, 102b, best seen in FIG. 9, and the first body portion 102a is nearest the puck 104. The first body portion 102a is octagonal in axial (i.e. lateral) cross-section. The first body portion 102a is tapered radially inwardly towards the puck 104. In other words, it is a truncated pyramid with an octagonal base and flat pyramidal sides. The second body portion 102b is circular in axial cross-section and its diameter is constant along its length. At the intersection of the first and second body portions 102a, 102b, the tool post 102 is radially stepped inwardly.

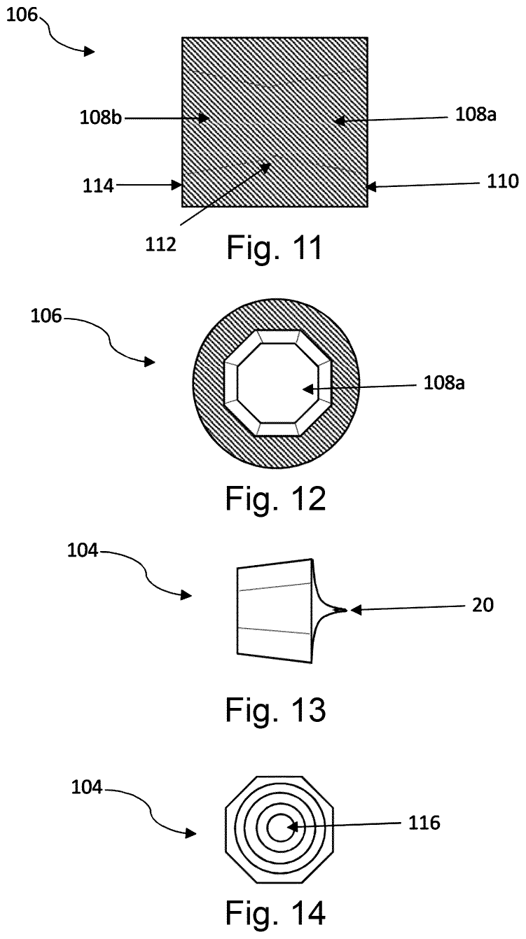

The joining collar 106 is externally cylindrical and has a central bore 108 extending axially along its length, as shown in FIGS. 11 and 12. The bore 108 is octagonal in axial cross-section. However, the size of the bore is not uniform along the length of the tool post 102. The bore 108 tapers radially inwardly from one end 110 of the joining collar 106 before inflecting at or near the midway point 112 to taper radially outwardly to the other end 114 of the joining collar 106, in an hourglass manner. In this way, the bore is divided into two adjoining cavities, a first bore cavity 108a for receiving the puck 104 and a second bore cavity 108b for receiving the tool post 102.

The puck 104 is octagonal in lateral cross-section. The size of the puck 104 matches that of the first body portion 102a of the tool post 102, as shown in FIG. 1. At one opposing end of the puck 104, distant from the tool post 102, the puck 104 is shaped into a stirring pin 20. The puck 104 tapers radially inwardly (indicated in FIG. 14 by concentric circles) to a tip in a known manner.

The puck 104 and the tool post 102 are separated axially by gap 22 and secured in position relative to each other by virtue of the joining collar 106.

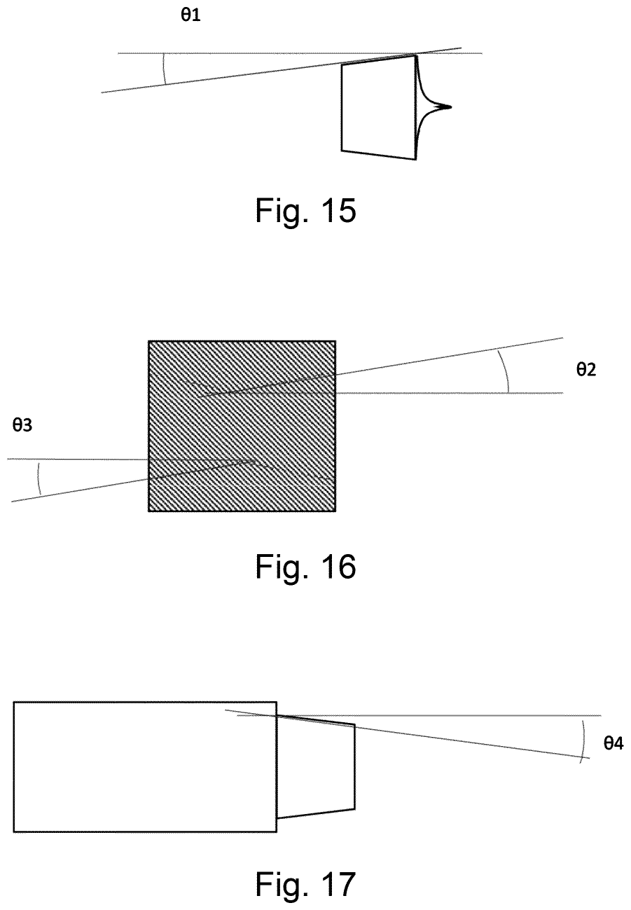

One feature of the invention is that the faceted super-abrasive puck 104 has a slight taper (taper angle θ1—see FIG. 15), with the corresponding bore 108 in the joining collar 106 which has facets in a tapered form (taper angle θ2—see FIG. 16), such that as the joining collar 106 expands, the super-abrasive puck 104 is pushed further into the joining collar 106 under the applied axial load, and thus remains a tight fit with the axis of the pin 116 both parallel with the axis of rotation 11 and in line with it.

The joining collar 106 may have a second slightly tapered set of facets entering from the other end (taper angle θ3—see FIG. 16), which fit to a similar set of tapered facets (taper angle θ4—see FIG. 17) on the W-C shaft 102. The design is such that both tapers allow the components to remain tightly fitted, and to this end when assembled, there remains a gap 22 between the tapered end of the W-C shaft 102 and the (smaller) tapered end of the super-abrasive puck 104 to ensure both are free to move further into the joining collar 106 to tighten in the taper.

The arrangement of the facets in the tool post 102, the puck 104 and/or the joining collar 106 is preferably rotationally periodic, with the number of facets being any number in the range four to eight inclusive, and being preferably six. For example, the left hand puck 104 in FIG. 18 has six facets X1 and the right hand puck in FIG. 18 has seven facets X1.

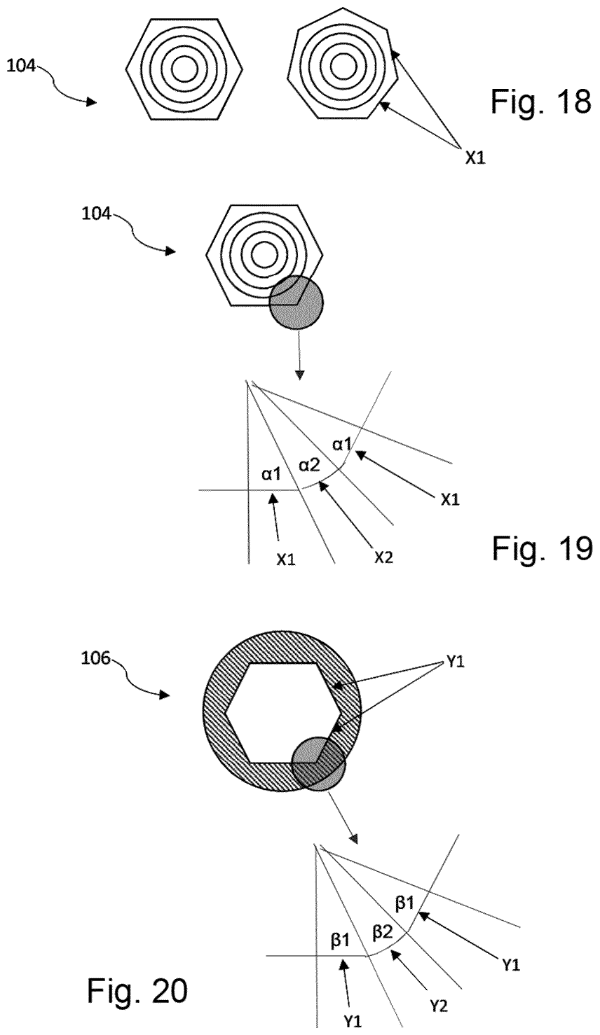

The facets X1 do not necessarily join at their edges, and as shown in FIG. 19; there may be a small segment of a cylindrical or conical surface X2 exposed between facets X1 forming a circular segment on any given cross-section. As a general rule, the angle of this circular segment X2 is much smaller than the angle of the facets X1, and preferably is there to simply break the corners between the facets X1 and improve robustness of individual elements 102, 104. The angle of the round sections X2 must be equal to or greater for external facets X1 on the inserted components (puck 104, tool post 106) than for similar internal facets Y1, Y2 of the joining collar 106 (see FIG. 20), to ensure a good fit between the components.

The minimum value and maximum value of the taper angle suitable for the application is set by the need to transfer sufficient torque, which provides for a minimum value of 2°, and a maximum value of 15°.

The precise angle of the tapers is significant in determining the extent to which the tapers are self-locking, and the ease with which they can be released. The two mating taper surfaces typically have the same or similar angles of taper, that is taper angle θ1 is the same or similar to taper angle θ2, and likewise is taper angle θ3 is the same or similar to taper angle θ4, but taper θ1 may differ significantly to taper angle θ3, depending on the details of the design used. The taper angles are generally chosen such that the assembly 100 self-locks under normal FSW operating conditions. That is, when the taper is under sufficient longitudinal compression, and with sufficient clearance to move, then any tendency for the joining collar 106 to expand away is mitigated by further mechanical insertion of the taper. As with most ceramic and brittle materials, super-abrasives and sintered super-abrasives are generally good under compression, so as long as the taper is designed to spread the compression load reasonably uniformly (e.g. taper angle θ1 is the same or similar to taper angle θ2), then the resulting high compression of the puck and W-C post after cool down of the tool is not an issue.

Thus, the angle of the taper can be within the range typically considered self-locking in more conventional applications, e.g. <7°, or as a result of the relatively high surface roughness of the super-abrasive composite, self-locking can be supported to slightly larger angles, up to 10°. Thus taper angles θ1, θ2 typically lie in the range 2°-15°, more typically 5°-10°, more typically 6°-8°.

In contrast, the taper angle for the tool post 102 may be smaller, since there is generally no intention to disassemble this part of the assembly. Thus, taper angles θ3, θ4 typically lie in the range 2°-15°, more typically 3°-8°, more typically 4°-7°.

Another feature of the invention is to be able to re-use the tool holder (i.e. tool post 102+ joining collar 106) and replace the super-abrasive puck 104, thereby reducing the overall cost of the tool. By re-useable, we mean that the tool holder can be used more than once for different super-abrasive pucks 104, typically 3-5 times or more. This is not possible with prior art designs of tool-holders for two reasons—i) the tool holder is not designed for removal of the puck 14, being parallel sided, and ii) the joining collar 16 invariably suffers damage from movement of the puck 14 if the puck 14 is not tightly clamped at operating temperatures. Puck 104 removal and replacement in the tool-holder does not necessarily have to be an operation suitable for the end user, provided it can be completed somewhere in the tool supply chain.

To facilitate puck 104 removal, a number of options can be adopted. For example, the joining collar 106 can be provided with two access apertures, typically located symmetrically on opposite sides of the joining collar 106, which allow the use of a wedge insert or similar to push out the puck 104. Alternatively, the tool post 102 can have a central hole running down its length, and an ejector rod can be used down this hole. A third alternative is to destructively remove the puck 104 by drilling into it and inserting an extractor pin which binds to the puck 104 using a screw thread, or expanding barbs, or similar. The precise design selected may depend on other aspects of the tool performance required, and on the type of heating used during the extraction process. The requirement to remove the puck 104 tends to push the wedge angles (θ1, θ2) associated with the puck 104 to higher angles, so that removal is made easier. The process of removing the puck 104 comprises heating the joining collar 106 to facilitate expansion and then driving the wedge in or using one of the other methods described above in order to facilitate release of the puck 104.

The means by which the tool 104 (i.e. puck) is heatable are various. One arrangement is to rapidly extract the tool 104 during a FSW operation and use the operating conditions for release. A second solution is to provide a heater module which fits around the joining collar 106 and heats it directly, either by flame, radiation, conduction or induction, in part dependent on the material used for the joining collar 106. Where suitable, induction is often the most effective solution, providing heat rapidly and directly to the component most requiring heating.

Another feature of the invention is in the choice of joining collar 106 materials. Having made the tool holder (tool post 102 and joining collar 106) re-useable, there is a much wider range of materials which can be considered commercially viable, (e.g. meeting a market acceptable price point), since more expensive materials can be considered. Conventional strong metals (e.g. based on iron) have CTE values around 11 ppm/° C., compared with CTE values of 4 ppm/° C. to 5 ppm/° C. of sintered PCBN and W-C. As such, the large difference in CTE is the major cause of the tool 104 becoming a sloppy fit at operating temperatures, with the use of a multi sided shrink fit collar. Strictly speaking, the CTE of a material is itself usually a function of temperature, and the key parameter becomes the total expansion from room temperature to operating conditions, which is equivalent to integrating the CTE as a function of temperature across the temperature change.

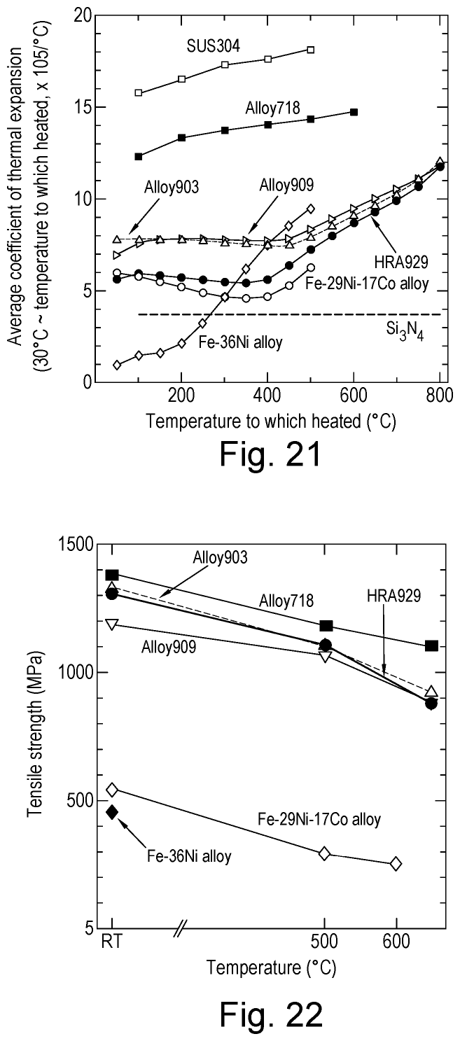

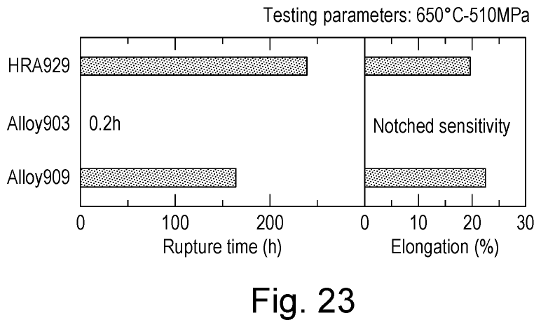

Although generally significantly more expensive than conventional metals, a number of bespoke alloys are known with CTE values substantially below 11 ppm/° C., at least over a portion of the temperature range from room temperature to 600° C., whilst at the same time retaining strength to high temperatures-see FIGS. 21, 22 and 23. In particular, alloys HRA 929, 909 and 903 all to varying degrees have a lower CTE at temperatures up to 600° C. than conventional steels, and 929 has a very similar CTE to W-C up to 400° C. This would minimise the risk of the collar expanding away from the PCBN or W-C elements it surrounds and mechanically clamps during normal operation, whilst still allowing for a higher temperature excursion to be used for assembly and disassembly of the tool.

In a second embodiment of the invention, the tool post 102 is sintered or diffusion bonded to the super-abrasive puck 104, and the joining collar 106 is omitted.

Since the puck 104 no longer suffers the high forces of excess run-out, or chattering impact within the joining collar 106 when it becomes loose in the joining collar 106, the toughness of the puck 104 can potentially be reduced and traded for increased wear resistance. As such, a range of other materials can be used for the metal binder within the super-abrasive puck 104. The advantage of this is that it then enables a range of other joining and assembly solutions, one option then being sintering or diffusion bonding a metal or W-C post 102 to the super-abrasive puck 104.

The sintered or diffusion bonded interface lies at some point along the longitudinal axis of the tool holder and generally orthogonal to it and rotationally symmetric about it, although particularly a sintered interface may have additional structures at the interface which break this rotational symmetry. Alternatively, it may take the form of a thin walled cone, filling the gap between two conical shaped and mating components. The interface may comprise of a single layer, or multiple layers. There remains a problem of dealing with the potential CTE mismatch between this interface layer and the rest of the assembly. Since the temperature excursion occurs mainly in connection with the puck 104 getting hot, and the puck 104 has a CTE around 4 ppm/° C. to 5 ppm/° C., then the three options are to:
1) Position the interface region sufficiently far away from the hot regions of the tool assembly in use, or to provide sufficiently effective cooling to ensure it stays cool and below a particular temperature threshold,
2) Keep the CTE of the interface region low, and in particular below a defined threshold, such that when the interface region gets hot the CTE mismatch between that and the puck is not excessive and does not cause thermal stresses sufficient to exceed the strength of the join or the adjacent components, or
3) To keep a smallest dimension of the interface region low, and below a specific threshold, such that the strain is accommodated within the interface region and the stress applied external to it is kept small.

As an example, the high strength and high entropy alloy TZM (TiZrMo) has a CTE of around 6 ppm/° C., which is fairly closely matched to the super-abrasive puck 104 (typically 4.5 ppm/° C.-5 ppm/° C.) where the CTE is dominated by the super-abrasive component such as PCBN. TZM can be used as the binder for the super-abrasive puck 104, and can also be used as the metal post 102 which is bonded to the back of the super-abrasive puck 104. Bonding may be by diffusion-bonding. Alternatively, the post 102 could be W-C, particularly in circumstances where the cost of a superalloy post would be greater than the cost of a W-C post, which depends on the particular superalloy chosen.

Diffusion bonding is a reversible process, in that at bonding temperatures it is also possible to disassemble the join if required, typically by sliding the components off sideways.

Alternatively, the super-abrasive puck 104 could be sintered to a backing layer of W-C during manufacture, and the subsequent bonding then take place to the W-C layer. One option here may be to bond to a post 102 also made of W-C, with the interface between the two W-C elements being a diffusion bond using a thin metal layer. As noted earlier, direct sintering onto a W-C post sufficiently large for mounting the tool directly into a FSW machine is difficult for tools of any significant size, (e.g. >4 mm pin length, as might be used in structural applications) because of the overall length of the shaft needed to both transfer the high torque from the FSW machine and at the same time minimise run-out would be large compared to the dimensions of the sintering capsule. However, it may be a possible solution for smaller pin lengths, such as might be used in automotive and fine metal engineering, when pin lengths of <4 mm and typically 2 mm would be appropriate.

As an alternative to more conventional metals such as the superalloy TZM, the super-abrasive binder may be a refractory high entropy alloy, comprising five or more metallic elements in a single phase metal, where the alloy remains single phase because of the high entropy (and thus low Gibbs free energy) associated with the entropy of the multiple constituents.

In a third embodiment of the invention, the tool post 102 is joined to the super-abrasive puck 104 with a friction spin join, and again, the joining collar 106 is omitted. This is where a join described above as a diffusion bonding is instead formed by using a friction spin weld or some other form of friction bonding such as a linear friction welding or ultrasonic friction welding. Such a bond would normally include a metal layer at the interface, in which the metal layer has a lower melting point than the two major elements being joined, and in which the layer has a smallest dimension which does not exceed 3 mm, preferably 2 mm, 1.5 mm, 1 mm, 0.5 mm, in part to minimise the stresses associated with the likely higher CTE of such a metal layer. Said interface layer is contiguous, and may comprise more than one material or sub-element.

For example, the interface material could be Al or Cu. In principle, the metal layer could even be steel, since friction bonding between W-C and steel has been demonstrated. The advantage of using a sufficiently low melting point metal is that, although the join may initially be formed by friction generated heating, the join may be disassembled by heating the entire unit to soften the join and then mechanically separating them, much as with the diffusion bond. Conversely, the melting point or softening point of the join material needs to be sufficiently high to not fail in tool use, although this can be supported by cooling of the tool holder as described later.

In each of the embodiments above, once a metallic element is connected to the super-abrasive puck, much more conventional solutions can be used to complete the remainder of the tool holder, for example a converter post which adapts the bespoke tool post of the FSW tool holder to a more standard sized tool holder as used on the FSW machine. A metal tool holder post also allows for a post which is tapered, but has a metal ‘key’ arrangement to transfer the torque. Typically such a metal key arrangement comprises a rectangular metal bar lying in a groove in the post taper, which groove runs in the plane of the longitudinal axis of the post and parallel to the wall of the taper, and with the rectangular metal bar engaging with a suitably matching groove in the taper within the FSW machine.

A further feature of the invention is to design a tool holder to manage and modify heat flow during operation, to reduce the deleterious effect of differential thermal expansion on reducing the binding between components, and ultimately to reduce the temperature excursion required to disassemble the tool again. This objective can be achieved in a number of ways, the first of which is to insert low thermal conductivity components, typically ceramics into the overall construction of the tool holder. A thermal barrier element, for example thin plate(s), could be inserted into the taper between the super-abrasive puck and the joining collar. This design would keep the ceramics under compression, and provide an additional option for disassembly which would be chemical attack on the ceramic spacers. Alternatively, in the gap 22 between the ends of the tool post 102 and the super-abrasive puck 104, one could place a thermal barrier element, this being a barrier to conduction, convection and/or radiation, in the form of a rock wool which was not compressed to the point of being significantly load bearing.

In addition to such passive solutions, active solutions for thermal management are also envisioned. A conventional solution would be a water-cooled jacket, either rotating with the tool and with a water feed and return that accommodate this, or static and positioned close to the tool. Alternatively water cooling could be provided down cooling channels in the post, for example by having a hole running down the centre of the post, perhaps with a tube feeding water to the bottom of the hole where the shaft attaches to the super-abrasive puck, and the return being constrained by the hole within the shaft. Methods of providing water-cooling into the centre of such a rotating shaft are known. To provide better control over the cooling effect, the liquid used may be other than water, for example an oil. One limitation of liquid cooling is that the potential phase change of the liquid to gas at the chosen pressure of operation provides a discontinuity in cooling rate and thus usually acts as an upper temperature limit on the allowable temperature at the boundary between cooled solid and cooling liquid. Such a limitation can be avoided by using gas cooling, where there is no further phase change to generate such a discontinuity in cooling effect. One option for gas cooling would be a set of fan blades, each conducting heat from the collar and driving the air motion to cool them. For safety reasons, this fan may need to be in an enclosing cylinder segment (static, or rotating along with it). Airflow would thus approximately parallel to the axis of the tool, typically directed towards the work piece, and may be used to cool the weld area as well. Rapid cooling of the weld (for example when welding under water) can result in a finer and better performing microstructure, and so the air-cooling can also be beneficial. Alternatively, gas cooling could be used down the hollow centre of the shaft replacing the water-cooling described above.

In brief, a friction stir welding tool assembly has been developed to minimise deleterious run-out during operation. This has been addressed by careful materials selection to reduce CTE mismatch and by astute structural design. The tool holder is reusable and the puck is replaceable.

1. A tool assembly for friction stir welding, the tool assembly comprising a tool holder and a puck each having an axis of rotation, the tool holder comprising a tool post and the puck comprising a pin, the puck being coupled to the tool post, wherein the tool assembly is adapted such that during friction stir welding, run-out of the tool holder, measured as the run-out between the axis of rotation of the tool holder and the axis of rotation of the pin, does not exceed 10 μm.

2. A tool assembly as claimed in claim 1, wherein the puck is coupled with the tool post by a diffusion bond.

3. A tool assembly as claimed in claim 1, wherein the puck is coupled with the tool post by a friction weld.

4. A tool assembly as claimed in claim 1, wherein the tool holder comprises an annular joining collar mountable about the tool post and about the puck to couple the tool post and the puck in axial alignment.

5. A tool assembly as claimed in claim 4, wherein the puck and the joining collar taper correspondingly inwardly towards the tool post.

6. A tool assembly as claimed in claim 5, wherein the puck tapers at an angle θ₁, angle θ₁ being in the range of 2° to 15°.

7. A tool assembly as claimed in claim 4, wherein the tool post and the joining collar taper correspondingly inwardly towards the puck.

8. A tool assembly as claimed in claim 7, wherein the tool post tapers at an angle θ₄, angle θ₄ being in the range of 2° to 15°.

9. A tool assembly as claimed in claim 4, wherein any one or more of the tool post, puck and joining collar is circular in axial cross-section.

10. A tool assembly as claimed in claim 4, wherein any one or more of the tool post, puck and joining collar is a polygon in axial cross-section.

11. A tool assembly as claimed in claim 10, wherein the puck comprises a set of radially outwardly facing facets and the joining collar comprises a set of radially inwardly facing facets, each set of facets extending radially inwardly towards the tool post.

12. A tool assembly as claimed in claim 10, wherein the tool post comprises a set of radially outwardly facing facets and the joining collar comprises a set of radially inwardly facing facets, each set of facets extending radially inwardly towards the puck.

13. A tool assembly as claimed in claim 11, comprising six, seven or eight facets in each set.

14. A tool assembly as claimed in claim 11, wherein each facet has four sides, two of said four sides being parallel to each other, the remaining two sides converging towards each other.

15. A tool assembly as claimed in claim 11, wherein each set of facets is arranged in series about the central axis.

16. (canceled)

17. A tool assembly as claimed in claim 15, wherein sequential facets about the central axis lay side-by-side connected by a rounded intersection.

18. A tool assembly as claimed in claim 4, wherein the joining collar comprises a material with a coefficient of thermal expansion (CTE) of less than 11 ppm/° C. for temperatures up to 600° C.

19-27. (canceled)

28. The tool assembly as claimed in claim 6, wherein angle θ₁ is in the range of 6° to 8°.

29. The tool assembly as claimed in claim 8, wherein angle θ₄ is in the range of 4° to 7°.
